(19) United States
(12) Patent Application Publication
(10) Pub. No.: US 2023/0390799 A1
(43) Pub. Date: Dec. 7, 2023

(54) COATING APPARATUS AND COATING METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Naomi SHIDA, Minato (JP); Katsuyuki NAITO, Bunkyo (JP); Yutaka SAITA, Yokohama (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/450,673

(22) Filed: Aug. 16, 2023

Related U.S. Application Data
(63) Continuation of application No. PCT/JP2022/006886, filed on Feb. 21, 2022.

(51) Int. Cl. B05C 5/02; B05C 1/08; B05D 1/28

(52) U.S. Cl. CPC B05C 5/0275; B05C 5/0291; B05C 1/0804; B05C 1/0813; B05D 1/28

(57) ABSTRACT

According to one embodiment of the invention, a coating apparatus includes a coating bar, a plurality of nozzles, a plurality of holding portions, and a detector. The coating bar is configured to face a coating target member. The plurality of nozzles are configured to supply a liquid toward the coating bar. One of the plurality of holding portions holds one of the plurality of nozzles. The one of the plurality of holding portions is configured to control a position of the one of the plurality of nozzles relative to the coating bar. The detector is configured to detect a quantity corresponding to respective positions of the plurality of nozzles with respect to the coating bar.

### CROSS-REFERENCE TO RELATED APPLICATIONS

This is a continuation application of International Application PCT/JP2022/006886, filed on Feb. 21, 2022; the entire contents of which are incorporated herein by reference.

### FIELD

Embodiment of the invention relates to a coating apparatus and a coating method.

### BACKGROUND

A coating apparatus that can form a uniform coated film is desirable.

### BRIEF DESCRIPTION OF THE DRAWINGS

FIG. 1 is a schematic plan view illustrating a coating apparatus according to a first embodiment;

FIG. 2 is a schematic side view illustrating the coating apparatus according to the first embodiment;

FIG. 3 is a schematic plan view illustrating the coating apparatus according to the first embodiment;

FIG. 4 is a schematic plan view illustrating a coating apparatus according to the first embodiment;

FIG. 5 is a schematic plan view illustrating a coating apparatus according to the first embodiment;

FIG. 6 is a schematic plan view illustrating a coating apparatus according to the first embodiment;

FIG. 7 is a schematic plan view illustrating a coating apparatus according to the first embodiment; and

FIG. 8 is a flowchart illustrating a coating method according to the second embodiment.

### DETAILED DESCRIPTION

According to one embodiment of the invention, a coating apparatus includes a coating bar, a plurality of nozzles, a plurality of holding portions, and a detector. The coating bar is configured to face a coating target member. The plurality of nozzles are configured to supply a liquid toward the coating bar. One of the plurality of holding portions holds one of the plurality of nozzles. The one of the plurality of holding portions is configured to control a position of the one of the plurality of nozzles relative to the coating bar. The detector is configured to detect a quantity corresponding to respective positions of the plurality of nozzles with respect to the coating bar.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously in an antecedent drawing are marked with like reference numerals, and a detailed description is omitted as appropriate.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

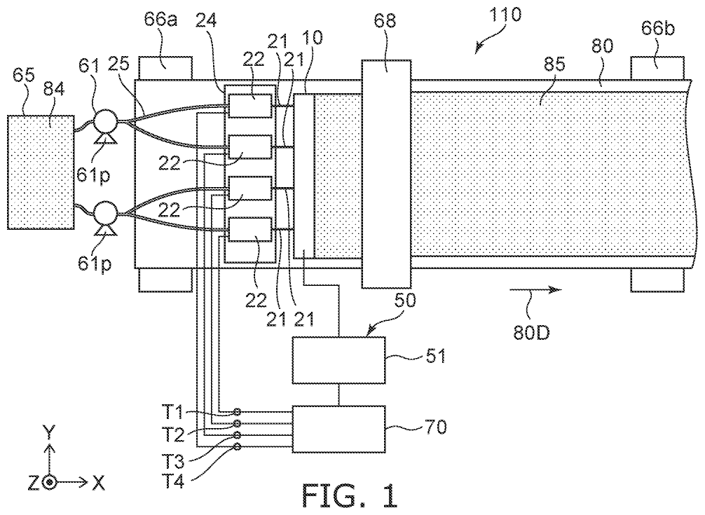

FIG. 1 is a schematic plan view illustrating a coating apparatus according to a first embodiment.

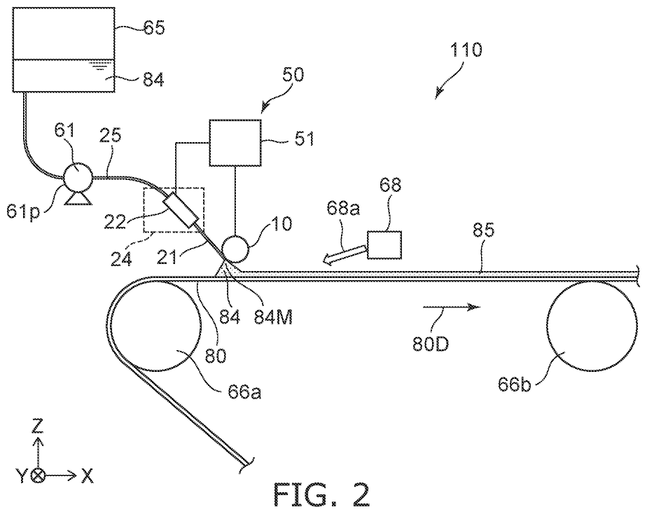

FIG. 2 is a schematic side view illustrating the coating apparatus according to the first embodiment.

As shown in FIG. 1 and FIG. 2, a coating apparatus 110 according to the embodiment includes a coating bar 10, a plurality of nozzles 21, a plurality of holding portions 22, and a detector 50.

The coating bar 10 can face a coating target member 80. The plurality of nozzles 21 can supply liquid 84 toward coating bar 10. A coating film 85 is formed on the coating target member 80 by the liquid 84 discharged from the plurality of nozzles 21.

One of the plurality of holding portions 22 holds one of the plurality of nozzles 21. One of the plurality of holding portions 22 can control the position of one of the plurality of nozzles 21 with respect to the coating bar 10. The respective positions of the plurality of nozzles 21 are fixed by the plurality of holding portions 22. The position is a position with the coating bar 10 as a reference.

The detector 50 can detect a quantity corresponding to each position of the plurality of nozzles 21 with respect to the coating bar 10. The detected quantity may include, for example, electrical resistance, sound, stress, light, and/or images. The detected quantity includes a quantity relating to the contact state with the coating bar 10 in the plurality of nozzles 21. The contact state includes the contact area of each of the plurality of nozzles 21 with the coating bar 10. The contact state may include the angle of each of the plurality of nozzles 21 with respect to the coating bar.

In the embodiment, the states of the plurality of nozzles 21 can be controlled by the plurality of holding portions 22 based on the detected results of the quantity corresponding to the positions of the plurality of nozzles 21. The spatial positional relationship of each of the plurality of nozzles 21 can be made uniform with respect to the coating bar 10. Thereby, the coating film 85 being uniform is obtained. In the embodiment, a coating apparatus capable of forming the coating film 85 being uniform can be provided.

In the embodiment, each of the plurality of nozzles 21 is in contact with the coating bar 10 in the coating. Each of the plurality of nozzles 21 contacts the coating bar 10 when the liquid 84 is supplied from the plurality of nozzles 21. Thereby, the positional relationship between the plurality of nozzles 21 and the coating bar 10 is stabilized. As a result, the coating state can be made uniform to some extent.

However, even when each of the plurality of nozzles 21 is in contact with the coating bar 10, the uniformity of the coating film 85 may be insufficient if the contact state of the plurality of nozzles 21 with the coating bar 10 is different.

In the embodiment, the detector 50 can detect the contact state of each of the plurality of nozzles with the coating bar 10. For example, the detector 50 can detect not only contact or non-contact but also the quantity corresponding to the area of the contact. The coating film 85 being more uniform can be obtained by detecting the contact state of each of the plurality of nozzles with the coating bar 10. The contact angle may be detected by the detector 50.

For example, when the contact area or contact angle between each of the plurality of nozzles 21 and the coating bar 10 changes, the electrical resistance between each of the plurality of nozzles 21 and the coating bar 10 changes. When the contact area, contact angle, or the like changes, sounds generated from the plurality of nozzles 21 change. When the contact area, contact angle, or the like changes, the stress received by each of the plurality of nozzles 21 changes. When the contact area, contact angle, or the like changes, light (for example, reflected light) from each of the plurality of nozzles 21 changes. When the contact area, contact angle, or the like changes, the shapes of the plurality of nozzles 21 change, and the images of the plurality of nozzles 21 change.

The detector 50 can detect these changes. For example, the plurality of holding portions 22 are controlled such that these quantities for the plurality of nozzles 21 are detected and the detected quantities are uniform among the plurality of nozzles 21. Thereby, the contact state of the plurality of nozzles 21 with the coating bar 10 can be made uniform.

As shown in FIG. 1, the coating apparatus 110 may include a controller 70. The controller 70 controls the plurality of holding portions 22 based on the quantity detected by the detector 50. Thereby, the position (contact state) of each of the plurality of nozzles 21 with respect to the coating bar 10 is appropriately controlled.

The detector 50 may detect the contact of at least one of the plurality of nozzles 21 with the coating bar 10.

As shown in FIG. 2, a meniscus 84M is formed by the liquid supplied from the plurality of nozzles 21 between the coating target member 80 and the coating bar 10. The meniscus 84M contacts the surface of the coating target member 80. By changing the relative position between the coating target member 80 and the coating bar 10, the coating film 85 is formed on the coating target member 80 with the liquid 84.

As shown in FIG. 1 and FIG. 2, in this example, the coating apparatus 110 includes a first transporter 66a and a second transporter 66b. These transporters are, for example, rollers. The coating target member 80 being sheet-shaped is moved along the transport direction 80D by these transporters. The meniscus 84M contacts a portion of the coating target member 80. In this example, roll-to-roll coating is performed.

The coating bar 10 extends along one direction. The one direction is, for example, a Y-axis direction. One direction perpendicular to the Y-axis direction is defined as an X-axis direction. A direction perpendicular to the Y-axis direction and the X-axis direction is defined as a Z-axis direction.

The transport direction 80D crosses the Y-axis direction. In this example, the transport direction 80D is the X-axis direction. The Z-axis direction corresponds to, for example, the height direction. The plurality of nozzles 21 may extend substantially along the transport direction 80D. The plurality of nozzles 21 may be inclined with respect to the transport direction 80D within the X-Z plane.

In this example, the liquid 84 is stored in a container 65. The liquid 84 is supplied to the plurality of nozzles 21 through the supply pipe 25 by the supply portion 61. The supply portion 61 is, for example, a pump 61p. In this example, a plurality of pumps 61p are provided. In this example, one of the plurality of pumps 61p is connected to a plurality of supply pipes 25. One of the plurality of supply pipes 25 is connected to one of the plurality of nozzles 21. The liquid 84 is supplied to the plurality of nozzles 21 by one of the plurality of pumps 61p.

As shown in FIG. 1 and FIG. 2, the coating apparatus 110 may include a support portion 24. The support portion 24 supports the plurality of holding portions 22. The support portion 24 can change the extending direction of the plurality of nozzles 21 by controlling the plurality of holding portions 22, for example, the angle of the extending direction of the support portion 24 (the angle along the rotation direction about the Z-axis direction) may be changed. By changing the angle of the extending direction of the support portion 24, the extending direction of the plurality of nozzles 21 may be collectively changed.

The support portion 24 can change the relative positions of the plurality of holding portions 22 with respect to the coating bar 10. The relative positions include, for example, positions in the X-axis direction and the Z-axis direction. The relative position includes, for example, the angle of the direction in which the plurality of holding portions 22 are arranged.

As shown in FIG. 1 and FIG. 2, the coating apparatus 110 may include a drying portion 68. The drying portion 68 can supply gas, heat, or the like toward the coating film 85. The gas may be, for example, heated air. Drying of the coating film 85 is accelerated. For example, the desired film may be obtained by drying the coating film 85 to become solid. The drying portion 68 may include, for example, air nozzles or far-infrared lamps.

In the coating apparatus 110 illustrated in FIG. 1, the detector 50 includes a resistance detector 51. The resistance detector 51 can detect electrical resistance between each of the plurality of nozzles 21 and the coating bar 10. The resistance detector 51 may include, for example, a resistance measurement circuit, a current measurement circuit, or a voltage measurement circuit.

For example, the coating apparatus 110 includes a plurality of terminals (terminals T1 to T4). One of the plurality of terminals is electrically connected to one of the plurality of nozzles 21. Another one of the plurality of terminals is electrically connected to another one of the plurality of nozzles 21.

The resistance detector 51 is electrically connected to the plurality of nozzles 21 via the plurality of terminals. The resistance detector 51 is electrically connected to the coating bar 10. With such a configuration, the resistance detector 51 detects electrical resistance between each of the plurality of nozzles 21 and the coating bar 10.

Excessively high electrical resistance results in no contact or insufficient contact. If the electrical resistance is too low, excessive contact occurs, for example, the plurality of nozzles 21 or coating bar 10 may be damaged, making stable coating difficult. When the electrical resistance is in the appropriate range, a suitable contact state can be uniformly obtained in the plurality of nozzles 21, and the coating film 85 being uniform can be obtained.

In one example, a suitable electrical resistance range is between not less than 10Ω and not more than 50Ω. A uniform coating film can be obtained by setting each of the plurality of nozzles 21 within this range.

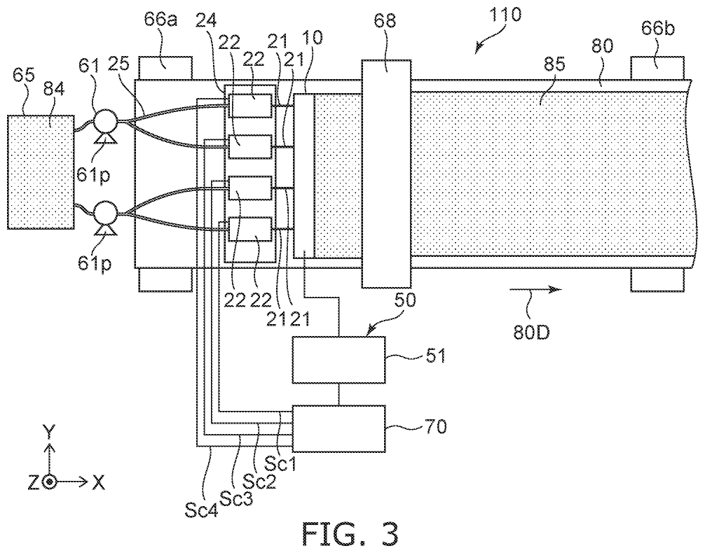

FIG. 3 is a schematic plan view illustrating the coating apparatus according to the first embodiment.

In FIG. 3, the plurality of terminals (terminals T1 to T4) and wires connected to them are omitted in order to make the figured easier to see. As shown in FIG. 3, the controller 70 can supply control signals (control signals Sc1 to Sc4, etc.) to each of the plurality of holding portions 22. The control signal is based on the quantity detected by the detector 50 (the quantity corresponding to the contact state). Thereby, the contact state of each of the plurality of nozzles 21 held by the plurality of holding portions 22 is controlled.

Thus, the controller 70 can control the plurality of holding portions 22 based on the quantity detected by the detector 50. The controller 70 can cause the holding portions 22 to control the positions (contact states) of the nozzles 21 with respect to the coating bar 10.

Another example of the detector will be described below.

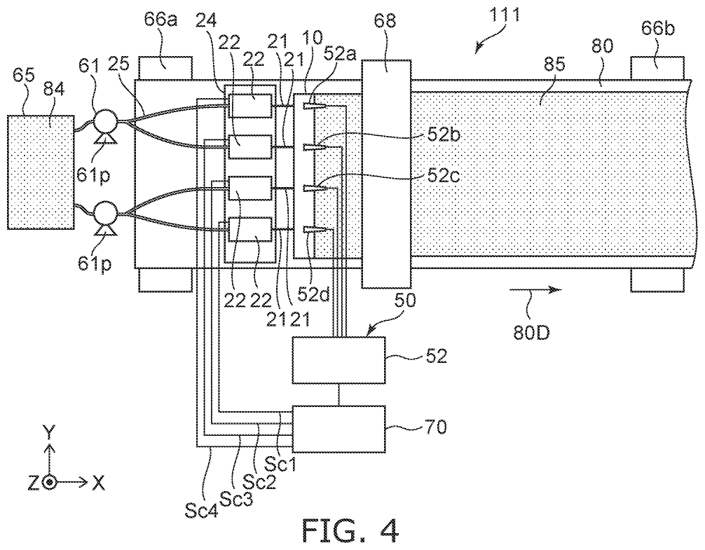

FIG. 4 is a schematic plan view illustrating a coating apparatus according to the first embodiment.

As shown in FIG. 4, in a coating apparatus 111 according to the embodiment, the detector 50 includes a sound detector 52. The sound detector 52 can detect sounds generated from each of the plurality of nozzles 21. The sound may include ultrasonic wave. Other configurations of the coating apparatus 111 may be the same as the configuration of the coating apparatus 110.

As shown in FIG. 4, the sound detector 52 may include, for example, a plurality of sound detecting elements (such as elements 52a to 52d). One of the plurality of sound detecting elements detects sound emitted from one of the plurality of nozzles 21. Another one of the plurality of sound detecting elements detects sound emitted from another one of the plurality of nozzles 21. With such a configuration, sounds generated from each of the plurality of nozzles 21 are detected. The sound detector 52 detects the volume of sound, frequency components included in the sound, and the like.

For example, lower and upper thresholds may be defined for sound parameters (such as loudness and frequency content). The controller 70 can compare the detected sound with a threshold value. Signals (control signals Sc1 to Sc4, etc.) corresponding to the comparison results are supplied from the controller 70 to the plurality of holding portions 22. The contact state of the plurality of nozzles 21 is controlled by the plurality of holding portions 22. The coating film 85 being uniform is obtained.

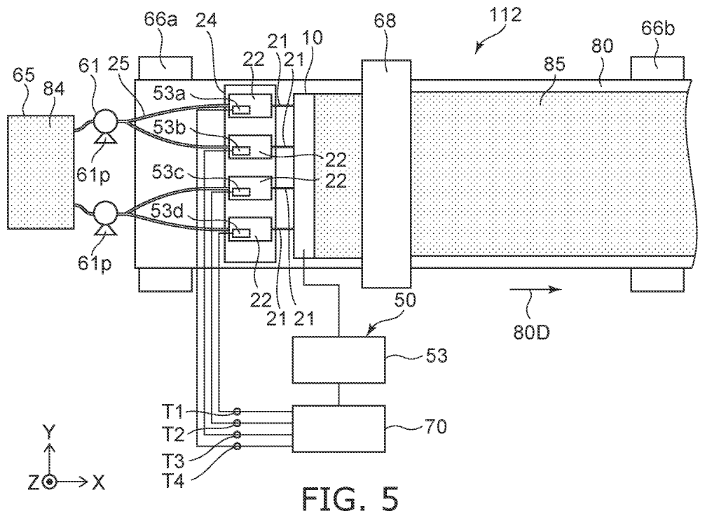

FIG. 5 is a schematic plan view illustrating a coating apparatus according to the first embodiment.

As shown in FIG. 5, in a coating apparatus 112 according to the embodiment, the detector 50 includes a stress detector 53. The stress detector 53 can detect stress applied to each of the plurality of nozzles 21. Other configurations of the coating apparatus 112 may be the same as the configurations of the coating apparatus 110.

For example, the stress detector 53 may include a plurality of stress detecting elements (such as elements 53a to 53d). One of the plurality of stress detecting elements is provided on one of the plurality of holding portions 22. Another one of the plurality of stress detecting elements is provided on another one of the plurality of holding portions 22. A stress applied to each of the plurality of nozzles 21 is detected by the plurality of stress detecting elements.

For example, the plurality of stress detecting elements (elements 53a to 53d, etc.) are electrically connected to the circuit portion of the stress detector 53 via the plurality of terminals (terminals T1 to T4, etc.).

For example, lower and upper thresholds can be defined for stress. The controller 70 can compare the detected stress with the threshold values. Signals (control signals Sc1 to Sc4, etc.) corresponding to the comparison results are supplied from the controller 70 to the plurality of holding portions 22. The contact state of the plurality of nozzles 21 is controlled by the plurality of holding portions 22. The coating film 85 being uniform is obtained.

The plurality of stress detecting elements may include, for example, piezoelectric elements. For example, the plurality of holding portions 22 may include an actuator or the like that changes the positions of the plurality of nozzles 21. The actuator may function as a plurality of stress detecting elements. For example, a drive voltage applied to the actuator may operate the actuator to control the plurality of nozzles 21. The drive voltage may be servo controlled. By servo-controlling the driving voltage according to the stress in the plurality of nozzles 21, the contact state of the plurality of nozzles 21 can be made uniform.

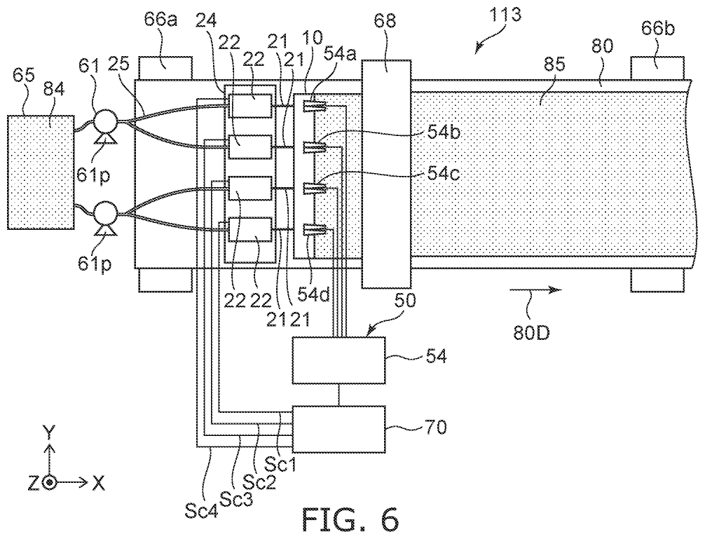

FIG. 6 is a schematic plan view illustrating a coating apparatus according to the first embodiment.

As shown in FIG. 6, in a coating apparatus 113 according to the embodiment, the detector 50 includes a photodetector 54. The photodetector 54 can detect light obtained from each of the plurality of nozzles 21. Other configurations of the coating apparatus 113 may be the same as the configuration of the coating apparatus 110.

For example, the photodetector 54 may include a plurality of light receiving elements (elements 54a to 54d, etc.). For example, the plurality of nozzles 21 are irradiated with light. The light is reflected by the plurality of nozzles 21. The reflected light corresponds to the contact state of each of the plurality of nozzles 21. By detecting the light from the plurality of nozzles 21 with the plurality of light receiving elements, the contact state of each of the plurality of nozzles 21 can be detected. The photodetector 54 may include a plurality of light emitting elements. The plurality of light emitting elements are provided corresponding to the plurality of light receiving elements.

For example, a lower threshold and an upper threshold may be defined for light. The controller 70 can compare the detected light with the threshold. Signals (control signals Sc1 to Sc4, etc.) corresponding to the comparison results are supplied from the controller 70 to the plurality of holding portions 22. The contact state of the plurality of nozzles 21 is controlled by the plurality of holding portions 22. The coating film 85 being uniform is obtained.

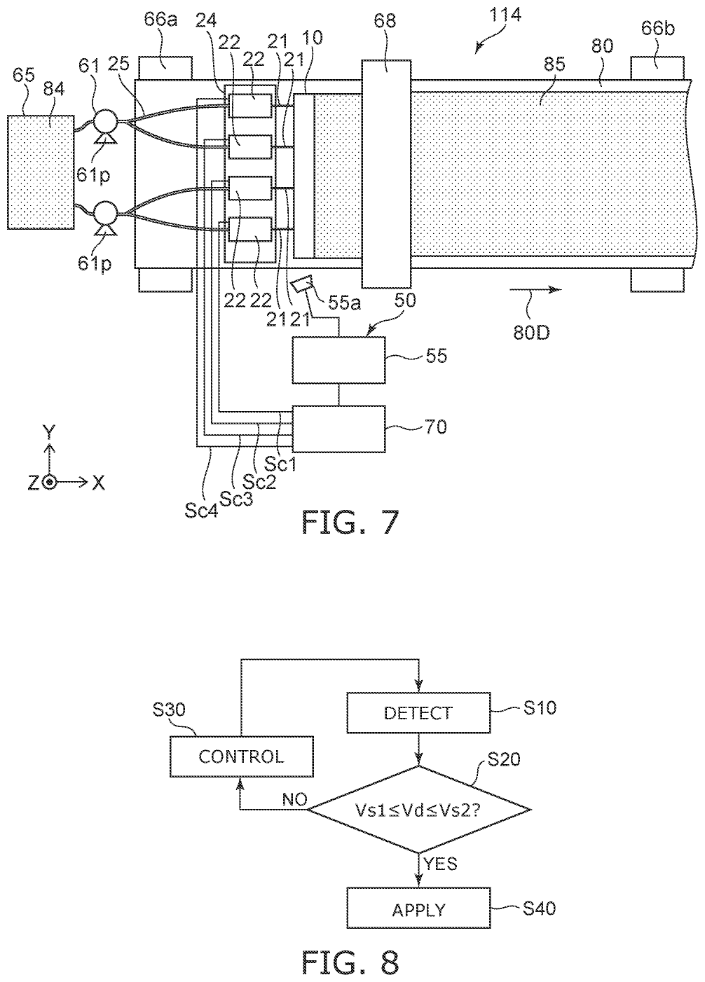

FIG. 7 is a schematic plan view illustrating a coating apparatus according to the first embodiment.

As shown in FIG. 7, in a coating apparatus 114 according to the embodiment, the detector 50 includes an imager 55. The imager 55 can detect images of each of the plurality of nozzles 21. Other configurations of the coating apparatus 113 may be the same as the configuration of the coating apparatus 110.

Each image of the plurality of nozzles 21 includes the contact state of each of the plurality of nozzles 21. For example, the imager 55 includes an imaging element 55a. The imaging element 55a captures an image of each of the plurality of nozzles 21. The imager 55 analyzes the image obtained by the imaging element 55a. Information about the contact state of each of the plurality of nozzles 21 is obtained from the image analysis results.

A lower threshold value and an upper threshold value can be defined for parameters obtained by image analysis. The controller 70 can compare the detected image with the thresholds. Signals (control signals Sc1 to Sc4, etc.) corresponding to the comparison results are supplied from the controller 70 to the plurality of holding portions 22. The contact state of the plurality of nozzles 21 is controlled by the plurality of holding portions 22. The coating film 85 being uniform is obtained.

In the embodiment, the plurality of nozzles 21 are needle-shaped, for example. For example, it is easy to control the discharge quantity of the liquid 84 with high accuracy. For example, the ends of the plurality of nozzles 21 are likely to come into contact with the coating bar 10. For example, it is easy to obtain high flexibility. Due to high flexibility, for example, it is easy to suppress damage to the plurality of nozzles 21. Each length of the plurality of nozzles 21 is, for example, not less than 10 mm and not more than 100 mm. Each inner diameter of the plurality of nozzles 21 is, for example, not less than 0.1 mm and not more than 2 mm. The angle between the end surface of each end of the plurality of nozzles 21 and the extending direction of each of the plurality of nozzles 21 is, for example, about 90 degrees (for example, not less than 75 degrees and not more than 105 degrees). For example, damage to the coating bar 10 can be easily suppressed. The plurality of nozzles 21 are electrically conductive.

Each of the plurality of nozzles 21 may include, for example, a locking base made of stainless steel. The supply pipe 25 may include, for example, polytetrafluoroethylene. The plurality of nozzles 21 and the supply pipe 25 may be connected by a detachable joint.

The cross-sectional shape of the coating bar 10 is arbitrary. The cross-sectional shape of the coating bar 10 may be circular, flattened circular or polygonal, for example. A part of the cross-sectional shape may be curved and the other part may be linear. For example, the cross-sectional shape of the surface of the coating bar 10 facing the coating target member 80 may be curved. When the cross-sectional shape of the coating bar 10 is circular, the radius of the circle is, for example, not less than 5 mm and not more than 50 mm. The length of the coating bar 10 is, for example, not less than 100 mm and not more than 5000 mm.

The coating bar 10 is electrically conductive. The coating bar 10 includes at least one selected from the group consisting of stainless steel, aluminum, titanium, nickel and copper, for example. Processing of the coating bar 10 becomes easy. In one example, the surface of the coating bar 10 is, for example, a mirror surface. In another example, the surface of coating bar 10 may include irregularities.

In one example, the number of pumps 61p is four. A pipe connected to one pump 61p is connected to four nozzles 21. The number of plurality of nozzles 21 is sixteen. The plurality of nozzles 21 are held by the plurality of holding portions 22, respectively. The plurality of holding portions 22 are supported by one support portion 24. The support portion 24 is, for example, a cantilever bar. It may be supported by multiple portions of the support portion 24. One of the holding portions 22 may include an actuator to displace the plurality of nozzles 21.

### Second Embodiment

The second embodiment relates to a coating method.

FIG. 8 is a flowchart illustrating a coating method according to the second embodiment.

As shown in FIG. 8, the coating method according to the embodiment includes detecting the quantity corresponding to each position of the plurality of nozzles with respect to the coating bar 10 (step S10). The coating bar 10 can face the coating target member 80. The above quantity relates to the state of contact of the plurality of nozzles 21 with the coating bar 10.

The coating method controls the plurality of holding portions 22 that respectively hold the plurality of nozzles 21 based on the above quantity. For example, the detected quantity Vd is compared with the lower threshold value Vs1 and the upper threshold value Vs2 (step S20). If the quantity Vd is not equal to or greater than the lower limit threshold value Vs1 and equal to or less than the upper limit threshold value Vs2, the plurality of holding portions 22 are controlled (step S30). After the step S30, the process returns to step S10. The process including steps S10, S20 and S30 may be performed repeatedly.

In the step S20, when the quantity Vd is equal to or greater than the lower threshold value Vs1 and equal to or less than the upper threshold value Vs2, the process proceeds to step S40. In the step S40, the liquid 84 is coated to the coating target member 80 by supplying the liquid 84 from the plurality of nozzles 21 to the coating bar 10.

In the coating method according to the embodiment, the quantity (for example, contact state) corresponding to each position of the plurality of nozzles with respect to the coating bar 10 is detected. Based on the detected quantity, the plurality of holding portions 22 are controlled to control the state of the plurality of nozzles 21. Thereby, the coating film 85 being uniform is obtained. According to the embodiments, it is possible to provide a coating method capable of forming a uniform coating film.

In the embodiment, the plurality of nozzles 21 may contact the coating bar 10 in the coating of the liquid 84. The detecting the above quantity may include detecting electrical resistance between each of the plurality of nozzles 21 and the coating bar 10. The detecting the quantity may include detecting sound generated from each of the plurality of nozzles 21. The detecting the above quantities may include detecting the stress applied to each of the plurality of nozzles 21. The detecting the quantity may include detecting light obtained from each of the plurality of nozzles 21. The detecting the quantity may include detecting an image of each of the plurality of nozzles. At least one position or angle of the plurality of nozzles 21 is controlled according to these detection results.

A solar cell may be formed by the coating apparatus 110 according to the embodiment and the coating method according to the embodiment.

The coating target member 80 is, for example, a PET film. An electrodes is provided on the PET film. The electrode is, for example, optically transparent. The electrode has a stacked structure of ITO (Indium Tin Oxide) film/Ag alloy/ITO film. The electrode may be formed by, for example, a roll-to-roll sputtering apparatus. For example, a plurality of electrodes may be provided. The width of one of the plurality of electrodes is, for example, approximately 20 mm. The distance between the electrodes is, for example, 50 μm.

In one example, liquid 84 forms a hole-transport layer. In this case, liquid 84 includes PEDOT (poly(3,4-ethylenedioxythiophene)) and PSS (polystyrene sulfonic acid). The liquid 84 is an aqueous solution. The angle between the extending direction of the plurality of nozzles 21 and the horizontal direction is 20 degrees. The moving speed of the coating target member 80 is, for example, 5 m/min.

In the embodiments, after the coating the hole-transport layer, another coating may be performed. The liquid 84 in another coating includes, for example, a semiconductor material. The other liquid includes, for example, PTB7 ([poly{4,8-bis[(2-ethylhexyl)oxy]benzo[1,2-b:4,5-b′]dithiophene-2,6-diyl-1t-alt-3-fluoro-2-[(2-ethylhexyl)carbonyl]thieno[3,4-b]thiophene-4,6-diyl}]) and PC70BM ([6,6]phenyl C71 butyric acid methyl ester). The liquid 84 further includes, for example, monochlorobenzene. The liquid 84 in the other coating becomes, for example, the semiconductor film of a solar cell.

An organic thin-film solar cell using an organic semiconductor or an organic/inorganic hybrid solar cell may be manufactured by the coating apparatus 110 according to the embodiment and the coating method according to the embodiment. High-performance, large-area solar cells can be manufactured.

The embodiments may include the following configurations (for example, technical proposals).

### (Configuration 1)

A coating apparatus, comprising:
a coating bar configured to face a coating target member;
a plurality of nozzles configured to supply a liquid toward the coating bar;
a plurality of holding portions, one of the plurality of holding portions holding one of the plurality of nozzles, the one of the plurality of holding portions being configured to control a position of the one of the plurality of nozzles relative to the coating bar; and
a detector configured to detect a quantity corresponding to respective positions of the plurality of nozzles with respect to the coating bar.

### (Configuration 2)

The coating apparatus according to Configuration 1, wherein
the detector is configured to detect a contact of at least one of the plurality of nozzles with the coating bar.

### (Configuration 3)

The coating apparatus according to Configuration 1, wherein
the detector includes a resistance detector, and
the resistance detector is configured to detect an electrical resistance between each of the plurality of nozzles and the coating bar.

### (Configuration 4)

The coating apparatus according to Configuration 3, further comprising:
a plurality of terminals,
one of the plurality of terminals being electrically connected to the one of the plurality of nozzles, and
another one of the plurality of terminals being electrically connected to another one of the plurality of nozzles.
   (Configuration 5) The coating apparatus according to Configuration 1, wherein
the detector includes a sound detector, and
the sound detector is configured to detect sounds generated from each of the plurality of nozzles.

### (Configuration 6)

The coating apparatus according to Configuration 1, wherein
the detector includes a stress detector, and
the stress detector is configured to detect stress applied to each of the plurality of nozzles.

### (Configuration 7)

The coating apparatus according to Configuration 6, wherein
the stress detector includes a plurality of stress detecting elements,
one of the plurality of stress detecting elements is provided in the one of the plurality of holding portions, and
another one of the plurality of stress detecting elements is provided on another one of the plurality of holding portions.

### (Configuration 8)

The coating apparatus according to Configuration 1, wherein
the detector includes a photodetector, and
the light detector is configured to detect a light obtained from each of the plurality of nozzles.

### (Configuration 9)

The coating apparatus according to Configuration 1, wherein
the detector includes an imager, and
the imager is configured to detect an image of each of the plurality of nozzles.

### (Configuration 10)

The coating apparatus according to any one of Configurations 1-9, further comprising:
a controller,
the controller being configured to control the plurality of holding portions based on the quantity detected by the detector to cause the plurality of holding portions to control respective positions of the plurality of nozzles with respect to the coating bar.

### (Configuration 11)

The coating apparatus according to any one of Configurations 1-10, further comprising:
a support portion,
the support portion supporting the plurality of holding portions, and
the support portion being configured to change relative positions of the plurality of holding portions with respect to the coating bar.

### (Configuration 12)

The coating apparatus according to any one of Configurations 1-10, further comprising:
a support portion,
the support portion supporting the plurality of holding portions, and
the support portion being configured to control the plurality of holding portions to change a direction in which the plurality of nozzles extends.

### (Configuration 13)

The coating apparatus according to any one of Configurations 1-11, wherein
a meniscus is configured to be formed between the coating target member and the coating bar by the liquid supplied from the plurality of nozzles.

### (Configuration 14)

A coating method, comprising:
detecting a quantity corresponding to each position of a plurality of nozzles with reference to a coating bar configured to face a coating target member; and
coating a liquid to the coating target member by supplying the liquid from the plurality of nozzles to the coating bar by controlling a plurality of holders respectively holding the plurality of nozzles based on the quantity, and controlling a position of each of the plurality of nozzles with respect to the coating bar.

### (Configuration 15)

The coating method according to Configuration 14, wherein
in the coating the liquid, the plurality of nozzles contact the coating bar.

### (Configuration 16)

The coating method according to Configuration 14, wherein
the detecting the quantity includes detecting an electrical resistance between each of the plurality of nozzles and the coating bar.

### (Configuration 17)

The coating method according to Configuration 14, wherein
the detecting the quantity includes detecting a sound generated from each of the plurality of nozzles.

### (Configuration 18)

The coating method according to Configuration 14, wherein
the detecting the quantity includes detecting a stress applied to each of the plurality of nozzles.

### (Configuration 19)

The coating method according to Configuration 14, wherein
the detecting the quantity includes detecting a light obtained from each of the plurality of nozzles.

### (Configuration 20)

The coating method according to Configuration 14, wherein
the detecting the quantity includes detecting an image of each of the plurality of nozzles.

According to the embodiments, a coating apparatus and coating method capable of forming a uniform coating film are provided.

Hereinabove, embodiments of the invention are described with reference to specific examples. However, the invention is not limited to these specific examples. One skilled in the art may similarly practice the invention by appropriately selecting specific configurations of components such as, for example, the coating bars, the nozzles, etc., included in the coating apparatuses from known art; and such practice is within the scope of the invention to the extent that similar effects can be obtained.

Furthermore, combinations of any two or more components of the specific examples within the extent of technical feasibility are within the scope of the invention to the extent that the purport of the invention is included.

Furthermore, all coating apparatuses and coating methods practicable by an appropriate design modification by one skilled in the art based on the coating apparatuses and the coating methods described above as embodiments of the invention also are within the scope of the invention to the extent that the purport of the invention is included.

Moreover, various modifications and alterations within the spirit of the invention will be readily apparent to those skilled in the art; and all such modifications and alterations should be seen as being within the scope of the invention.

While certain embodiments of the inventions have been described, these embodiments have been presented by way of example only, and are not intended to limit the scope of the inventions. These novel embodiments may be embodied in a variety of other forms; and various omissions, substitutions, and changes may be made without departing from the spirit of the inventions. Such embodiments and their modifications are within the scope and spirit of the inventions and are included in the inventions described in the claims and their equivalents.

What is claimed is:

1. A coating apparatus, comprising:
a coating bar configured to face a coating target member;
a plurality of nozzles configured to supply a liquid toward the coating bar;
a plurality of holding portions, one of the plurality of holding portions holding one of the plurality of nozzles, the one of the plurality of holding portions being configured to control a position of the one of the plurality of nozzles relative to the coating bar; and
a detector configured to detect a quantity corresponding to respective positions of the plurality of nozzles with respect to the coating bar.

2. The coating apparatus according to claim 1, wherein
the detector is configured to detect a contact of at least one of the plurality of nozzles with the coating bar.

3. The coating apparatus according to claim 1, wherein
the detector includes a resistance detector, and
the resistance detector is configured to detect an electrical resistance between each of the plurality of nozzles and the coating bar.

4. The coating apparatus according to claim 3, further comprising:
a plurality of terminals,
one of the plurality of terminals being electrically connected to the one of the plurality of nozzles, and
another one of the plurality of terminals being electrically connected to another one of the plurality of nozzles.

5. The coating apparatus according to claim 1, wherein
the detector includes a sound detector, and
the sound detector is configured to detect sounds generated from each of the plurality of nozzles.

6. The coating apparatus according to claim 1, wherein
the detector includes a stress detector, and
the stress detector is configured to detect stress applied to each of the plurality of nozzles.

7. The coating apparatus according to claim 6, wherein
the stress detector includes a plurality of stress detecting elements,
one of the plurality of stress detecting elements is provided in the one of the plurality of holding portions, and
another one of the plurality of stress detecting elements is provided on another one of the plurality of holding portions.

8. The coating apparatus according to claim 1, wherein
the detector includes a photodetector, and
the light detector is configured to detect a light obtained from each of the plurality of nozzles.

9. The coating apparatus according to claim 1, wherein
the detector includes an imager, and
the imager is configured to detect an image of each of the plurality of nozzles.

10. The coating apparatus according to claim 1, further comprising:
a controller,
the controller being configured to control the plurality of holding portions based on the quantity detected by the detector to cause the plurality of holding portions to control respective positions of the plurality of nozzles with respect to the coating bar.

11. The coating apparatus according to claim 1, further comprising:
a support portion,
the support portion supporting the plurality of holding portions, and
the support portion being configured to change relative positions of the plurality of holding portions with respect to the coating bar.

12. The coating apparatus according to claim 1, further comprising:
a support portion,
the support portion supporting the plurality of holding portions, and
the support portion being configured to control the plurality of holding portions to change a direction in which the plurality of nozzles extends.

13. The coating apparatus according to claim 1, wherein
a meniscus is configured to be formed between the coating target member and the coating bar by the liquid supplied from the plurality of nozzles.

14. A coating method, comprising:
detecting a quantity corresponding to each position of a plurality of nozzles with reference to a coating bar configured to face a coating target member; and
coating a liquid to the coating target member by supplying the liquid from the plurality of nozzles to the coating bar by controlling a plurality of holders respectively holding the plurality of nozzles based on the quantity, and controlling a position of each of the plurality of nozzles with respect to the coating bar.

15. The coating method according to claim 14, wherein
in the coating the liquid, the plurality of nozzles contact the coating bar.

16. The coating method according to claim 14, wherein
the detecting the quantity includes detecting an electrical resistance between each of the plurality of nozzles and the coating bar.

17. The coating method according to claim 14, wherein
the detecting the quantity includes detecting a sound generated from each of the plurality of nozzles.

18. The coating method according to claim 14, wherein
the detecting the quantity includes detecting a stress applied to each of the plurality of nozzles.

19. The coating method according to claim 14, wherein
the detecting the quantity includes detecting a light obtained from each of the plurality of nozzles.

20. The coating method according to claim 14, wherein
the detecting the quantity includes detecting an image of each of the plurality of nozzles.
